(19) United States
(12) Patent Application Publication
(10) Pub. No.: US 2008/0076009 A1
(43) Pub. Date: Mar. 27, 2008

(54) SOLID ELECTROLYTE MEMBRANE, METHOD OF MANUFACTURING SOLID ELECTROLYTE MEMBRANE, FUEL CELL PROVIDED WITH SOLID ELECTROLYTE MEMBRANE, AND METHOD OF MANUFACTURING FUEL CELL

(75) Inventors: Akiko Saito, Kanagawa-ken (JP); Jun Momma, Kanagawa-ken (JP); Naoya Hayamizu, Kanagawa-ken (JP); Yukihiro Shibata, Kanagawa-ken (JP); Hideo Oota, Tokyo (JP); Kazuhiro Yasuda, Kanagawa-ken (JP); Yoshihiko Nakano, Kanagawa-ken (JP)

Correspondence Address: PEARNE & GORDON LLP, 1801 EAST 9TH STREET, SUITE 1200, CLEVELAND, OH, 44114-3108, US

(73) Assignee: KABUSHIKI KAISHA TOSHIBA, Tokyo (JP)

(21) Appl. No.: 11/689,208

(22) Filed: Mar. 21, 2007

(30) Foreign Application Priority Data
Sep. 25, 2006 (JP) 2006-259303
Sep. 25, 2006 (JP) 2006-259537

(51) Int. Cl. H01M 2/14; B05D 5/12; H01M 8/00

(52) U.S. Cl. 429/41; 29/592.1; 427/115; 429/12

(57) ABSTRACT

A solid electrolyte membrane includes: a porous material layer and an inorganic material layer. The porous material layer has a through-hole that is filled with an electrolyte. The inorganic material layer is provided so as to face to at least either side of a principal surface of the porous material layer and has an opening that is filled with an electrolyte. A solid electrolyte membrane alternatively includes: a first porous layer and a second porous layer. The first porous layer has a through-hole that is filled with an electrolyte. The second porous layer is provided so as to face to at least either side of a principal surface of the first porous layer and has an opening that is filled with an electrolyte. The average diameter of the opening is smaller than the average diameter of the through-hole.

### CROSS-REFERENCE TO RELATED APPLICATIONS

This application is based upon and claims the benefit of priorities from the prior Japanese Patent Application No. 2006-259303, filed on Sep. 25, 2006, and the prior Japanese Patent Application No. 2006-259537, filed on Sep. 25, 2006; the entire contents of which are incorporated herein by reference.

### BACKGROUND OF THE INVENTION

1. Field of the Invention

The present invention relates to a solid electrolyte membrane, a method of manufacturing the solid electrolyte membrane, a fuel cell provided with the solid electrolyte membrane, and a method of manufacturing the fuel cell.

2. Background Art

Along with the recent progress in electronic technique, there are also advances in miniaturization, enhancing the performance and portableness of electronic devices, and demand for miniaturization and energy density growth of batteries used for these are increasing. Fuel cells that have a high capacity irrespective of its medium to small size and light weight attract attention.

Especially, a direct methanol fuel cell (DMFC) that uses methanol as fuel is suitable for miniaturization compared with a fuel cell that uses hydrogen gas, because there are no such problems as difficulty in the handling of hydrogen gas and devices for producing hydrogen by reforming organic fuel. In the direct methanol fuel cell, methanol and water are supplied to the anode electrode, and the methanol and the water are reacted in the presence of a catalyst that is disposed near a solid electrolyte membrane to take out protons (H⁺) and electrons (e⁻). In the direct methanol fuel cell, however, there is such a problem that a phenomenon referred to as “methanol crossover,” in which the methanol permeates through the solid electrolyte membrane that is disposed between the anode electrode and the cathode electrode, occurs to lower significantly the generating efficiency.

Therefore, a porous solid electrolyte membrane capable of preventing the methanol crossover is proposed (refer to JP-A-2005-285413, JP-A-2005-276747, JP-A-2005-268032).

### SUMMARY OF THE INVENTION

According to an aspect of the invention, there is provided a solid electrolyte membrane including: a porous material layer having a through-hole that is filled with an electrolyte, and an inorganic material layer that is provided so as to face to at least either side of a principal surface of the porous material layer and has an opening that is filled with an electrolyte.

According to another aspect of the invention, there is provided a solid electrolyte membrane including: a first porous layer having a through-hole that is filled with an electrolyte, and a second porous layer that is provided so as to face to at least either side of a principal surface of the first porous layer and has an opening that is filled with an electrolyte, the average diameter of the opening being smaller than the average diameter of the through-hole.

According to another aspect of the invention, there is provided a method of manufacturing a solid electrolyte membrane including: forming an inorganic material layer so as to face to a principal surface of a porous material layer having a through-hole; forming an opening for the inorganic material layer; and filling the through-hole and the opening with an electrolyte.

According to another aspect of the invention, there is provided a method of manufacturing a solid electrolyte membrane including: forming a first porous layer having a through-hole; forming a second porous layer having an opening; putting the second porous layer on a principal surface of the first porous layer; and filling the through-hole and the opening with an electrolyte.

According to another aspect of the invention, there is provided a fuel cell including: the solid electrolyte membrane including: a porous material layer having a through-hole that is filled with an electrolyte, and an inorganic material layer that is provided so as to face to at least either side of a principal surface of the porous material layer and has an opening that is filled with an electrolyte; a cathode electrode; and an anode electrode.

According to another aspect of the invention, there is provided a fuel cell including: a first porous layer having a through-hole that is filled with an electrolyte, and a second porous layer that is provided so as to face to at least either side of a principal surface of the first porous layer and has an opening that is filled with an electrolyte, the average diameter of the opening being smaller than the average diameter of the through-hole; a cathode electrode; and an anode electrode.

According to another aspect of the invention, there is provided a method of manufacturing a fuel cell including: producing a solid electrolyte membrane including: forming an inorganic material layer so as to face to a principal surface of a porous material layer having a through-hole; forming an opening for the inorganic material layer; and filling the through-hole and the opening with an electrolyte; forming a current collector on a cathode electrode side and forming a catalyst thereon to form a cathode electrode; forming a current collector on an anode electrode side and forming a catalyst thereon to form an anode electrode; and joining the cathode electrode and the anode electrode on both sides of the solid electrolyte membrane.

According to another aspect of the invention, there is provided a method of manufacturing a fuel cell including: producing a solid electrolyte membrane including: forming a first porous layer having a through-hole; forming a second porous layer having an opening; putting the second porous layer on a principal surface of the first porous layer; and filling the through-hole and the opening with an electrolyte; forming a current collector on a cathode electrode side and forming a catalyst thereon to form a cathode electrode; forming a current collector on an anode electrode side and forming a catalyst thereon to form an anode electrode; and joining the cathode electrode and the anode electrode on both sides of the solid electrolyte membrane.

### BRIEF DESCRIPTION OF THE DRAWINGS

FIG. 1 is a schematic cross-sectional view for illustrating the solid electrolyte membrane according to a first embodiment of the present invention.

FIG. 2 is a schematic view for illustrating such an instance that the aperture figure of openings is made circular and the openings are arranged in a zigzag shape.

FIG. 3 is a schematic view for illustrating such an instance that the aperture figure of openings is made regular hexagonal and the openings are arranged so as to be plane filling.

FIG. 4 is a schematic cross-sectional view for illustrating the solid electrolyte membrane according to a second Example of the first embodiment.

FIG. 5 is a schematic cross-sectional view for illustrating the solid electrolyte membrane according to a third Example of the first embodiment.

FIG. 6 is a flowchart for illustrating the method of manufacturing the solid electrolyte membrane according to a fourth Example of the first embodiment.

FIG. 7 is a schematic view for illustrating the fuel cell according to a fifth Example of the first embodiment.

FIG. 8 is a flowchart for illustrating the method of manufacturing the fuel cell according to a sixth Example of the first embodiment.

FIG. 9 is a schematic cross-sectional view for illustrating the solid electrolyte membrane according to the second embodiment of the present invention.

FIG. 10 is a schematic view for illustrating an instance of making the aperture figure of the through-holes and the openings circular and arranging them in a zigzag shape.

FIG. 11 is a schematic view for illustrating the aperture figure of the through-holes and the openings, and the opening ratio thereof.

FIG. 12 is a schematic view for illustrating the instance of making the aperture figure of the through-holes and the openings regular hexagonal and arranging them so as to be in plane filling (honeycomb construction).

FIG. 13 is a schematic cross-sectional view for illustrating the solid electrolyte membrane according to the second Example of the second embodiment.

FIG. 14 is a schematic cross-sectional view for illustrating the solid electrolyte membrane according to the third Example of the second embodiment.

FIG. 15 is a schematic view for illustrating the solid electrolyte membrane according to the fourth Example of the second embodiment.

FIG. 16 is a flowchart for illustrating the method of manufacturing the solid electrolyte membrane according to the fifth Example of the second embodiment.

FIG. 17 is a schematic view for illustrating the fuel cell according to the sixth Example of the second embodiment.

FIG. 18 is a flowchart for illustrating the method of manufacturing a fuel cell according to the seventh Example of the second embodiment.

### DETAILED DESCRIPTION OF THE INVENTION

Hereinafter, the embodiments of the present invention are described with reference to the drawings.

### First Embodiment

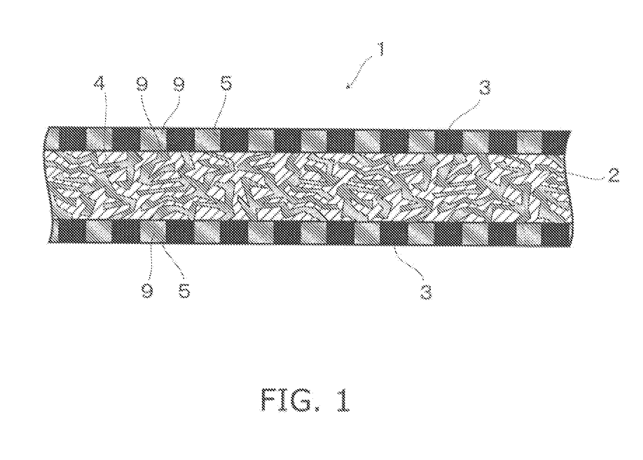

FIG. 1 is a schematic cross-sectional view for illustrating the solid electrolyte membrane according to a first embodiment of the present invention. The solid electrolyte membrane 1 is provided with a porous material layer 2 and an inorganic material layer 3 formed on both sides of the principal surface thereof. In the porous material layer 2, there are provided through-holes 4 in a labyrinth figure, and in the inorganic material layer 3, there are provided openings 5. The through-hole 4 and the opening 5 are filled with an electrolyte 9.

The porous material layer 2 has such functions as the proton (H⁺) conduction and preventing the permeation of organic fuel (e.g., methanol crossover). As described later, the inorganic material layer 3 has such function that it singly does not prevent the permeation of organic fuel (e.g., methanol crossover), but that it blocks the size change of the porous material layer 2 to prevent the permeation of organic fuel (e.g., methanol crossover).

The reason for forming the through-holes 4 in a labyrinth figure is to think much of the function for preventing the permeation of organic fuel (e.g., methanol crossover). The reason for forming the holes that are provided in the inorganic material layer 3 as the openings 5 (straight hole) is to think much of the proton (H⁺) conductivity. If they are formed in a labyrinth figure as is the case for the through-holes 4, there will occur a problem in the proton (H⁺) conductivity of the overall solid electrolyte membrane 1.

The porous material layer 2 can be constituted of a heat-resistant organic material, inorganic material, or composite material thereof.

Specifically, examples of the organic material include polyethylene, polypropylene, polyimide, polyamide, polyetherimide, polyether ether ketone, polytetrafluoroethylene, tetrafluoroethylene-ethylene copolymer, tetrafluoroethylene-propylene copolymer, tetrafluoroethylene-hexafluoropropylene copolymer, polyvinylidene fluoride, tetrafluoroethylene-perfluoroalkoxyethylene copolymer, polysulfone, polyphenylene sulfide, polyarylate, polyether sulfone, polysilazane; examples of the inorganic material include silicon oxide, silicon carbide, silicon nitride, alumina, zirconium oxide, ceria, lead oxide, bismuth oxide, boron oxide; and the examples of the composite material include polypropylene compositely immixed with glass fiber or organic fiber.

Of these, the porous material layer 2 is more preferably constituted of an organic material or a composite material, because an organic material or a composite material makes it possible to form a thinner solid electrolyte membrane 1 to result in the advantage for the proton (H⁺) conduction. In addition, because an organic material and a composite material abound in flexibility, have resistance to a break and a crack, and are suitable for miniaturization.

For a method of providing these materials with the through-holes 4 in a labyrinth figure, such publicly known chemical or physical method as a phase separation method, a foaming method or a sol-gel method can be employed.

The inorganic material layer 3 can be constituted from a heat-resistant inorganic material. Specific examples include silicon, silicon oxide, silicon nitride, aluminum oxide, boron oxide, bismuth oxide, barium oxide, zinc oxide, magnesium oxide, calcium oxide, strontium oxide, lithium oxide, sodium oxide, and potassium oxide. The method for providing these materials with the openings 5 is described later.

The material of the electrolyte 9 to be filled into the through-holes 4 and the openings 5 can be one having a hydroxyl group, a carboxyl group, a sulfone group, an ester group formed by the reaction of at least two types of the carboxyl group and the sulfone group, or ether group in the skeleton thereof. Specific examples include ones having polytetrafluoroethylene as a main component, polyvinyl sulfonic acid, polystyrene sulfonic acid and poly(a-methylstyrene) sulfonic acid. A method for filling the material into the through-holes 4 and the openings 5 is described later.

The thickness of the porous material layer 2 is preferably from 0.01 μm to 100 μm. A thickness of smaller than 0.01 μm results in a too low strength as the solid electrolyte membrane 1, and a thickness of greater than 100 μm results in a too long passing distance of proton (H⁺) to give rise to a problem in the conductivity of the proton. In this case, the thickness is more preferably from 10 μm to 30 μm while thinking much of the proton (H⁺) conductivity.

In case where, for example, the porous material layer 2 is formed from an organic material alone, a preferred thickness is around 10 μm or greater while taking the easiness of the production and the handling into consideration. But, in case where it is formed from an inorganic material alone or a composite material, the thickness can be made smaller than 10 μm.

The pore diameter of the through-holes 4 in the porous material layer 2 is preferably from 0.01 μm to 200 μm. Because, a diameter of smaller than 0.01 μm gives rise to a problem in the proton (H⁺) conductivity, and a diameter of greater than 200 μm makes it difficult to inhibit the permeation of organic fuel (e.g., methanol crossover) by the inorganic material layer 3 which is described later. In this case, the diameter is more preferably from 0.1 μm to 10 μm while taking the balance between these into consideration. The pore diameter is a diameter that is obtained by converting the aperture figure of the through-holes 4 into a circle.

The porosity of the through-holes 4 in the porous material layer 2 is preferably from 30% to 80%. Because, a porosity of smaller than 30% gives rise to a problem in the proton (H⁺) conductivity, and a porosity of greater than 80% makes it difficult to inhibit the permeation of organic fuel (e.g., methanol crossover) by the inorganic material layer 3 which is described later. In this case, the porosity is more preferably form 30% to 60% while taking the inhibition of the permeation of organic fuel (e.g., methanol crossover) into consideration.

The thickness of the inorganic material layer 3 is preferably from 0.01 μm to 100 μm. Because, when the thickness is smaller than 0.01 μm, the strength of the inorganic material layer 3 is lowered to result in the reduction of the after-mentioned effect on inhibiting the permeation of organic fuel (e.g., methanol crossover) due to the swelling of the porous material layer 2; and when the thickness is greater than 100 μm, a passing distance of proton (H⁺) is lengthened to give rise to a problem in the proton (H⁺) conductivity. In this case, for example, while thinking much of the effect on inhibiting the permeation of organic fuel (e.g., methanol crossover) due to the swelling of the porous material layer 2, the thickness is more preferably from 0.5 μm to 10 μm.

The pore diameter of the opening 5 in the inorganic material layer 3 is preferably from 0.01 μm to 200 μm. Because, when the diameter is smaller than 0.01 μm, there occurs a problem in the proton (H⁺) conductivity; and when the diameter is greater than 200 μm, the strength of the inorganic material layer 3 is lowered to result in reducing the after-mentioned effect on inhibiting the permeation of organic fuel (e.g., methanol crossover) due to the swelling of the porous material layer 2. In this case, while taking the balance between these into consideration, the diameter is more preferably from 0.1 μm to 10 μm. In addition, for example, when taking the easiness of the processing into consideration, the diameter can be 0.05 μm or greater. The pore diameter is a diameter that is obtained by converting the aperture figure of the openings 5 into a circle.

The opening ratio of the openings 5 in the inorganic material layer 3 is preferably from 20% to 90%. Because, when the ratio is smaller than 20%, there occurs a problem in the proton (H⁺) conductivity; and when the ratio is greater than 90%, the strength of the inorganic material layer 3 is lowered to reduce the after-mentioned effect on inhibiting the permeation of organic fuel (e.g., methanol crossover) due to the swelling of the porous material layer 2. In this case, while thinking much of the proton (H⁺) conductivity, the ratio is more preferably from 50% to 80%.

The ratio of the pore diameter of the opening 5 in the inorganic material layer 3 to the thickness of the inorganic material layer 3 (the pore diameter of the opening 5 in the inorganic material layer 3/the thickness of the inorganic material layer 3) is preferably 100 or less while taking the balance between the proton (H⁺) conductivity and the effect on inhibiting the permeation of organic fuel (e.g., methanol crossover) due to the swelling into consideration. Further, when thinking much of the effect on inhibiting the permeation of organic fuel (e.g., methanol crossover) due to the swelling while ensuring the proton (H⁺) conductivity, the ratio is more preferably 1 or less.

The aperture figure and the arrangement of the openings 5 in the inorganic material layer 3 are described.

A “circular” aperture figure of the openings 5 can reduce the stress concentration and inhibit the lowering in the strength of the inorganic material layer 3 caused by the existence of the pore. An “angular” aperture figure of the openings 5 allows the opening ratio to be increased as compared with the case of “circular” one because the space between the adjacent pores can be used effectively. In case where the “angular” figure is a regular polygon capable of attaining the plane filling (regular triangle, regular tetragon, regular hexagon), the opening ratio can be made highest. The openings 5 can be so arranged that they are in a reticular pattern, or in the plane filling. In particular, in case where regular hexagons are arranged so as to be in the plane filling (honeycomb construction), the opening ratio can be made highest while minimizing the lowering of the strength of the inorganic material layer 3 caused by the existence of the pores.

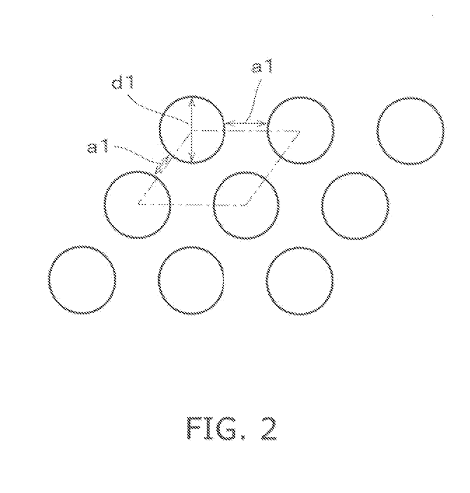

FIG. 2 is a schematic view for illustrating an instance in which the openings 5 are formed to have a circular aperture figure and arranged in a zigzag shape. In the instance as shown in FIG. 2, the diameter d1 of the opening 5 is 10 μm, and the space a1 between the adjacent pores is 2 μm. The opening ratio at this time is 63.9%. When the space a1 is 3 μm, the opening ratio is 53.4%.

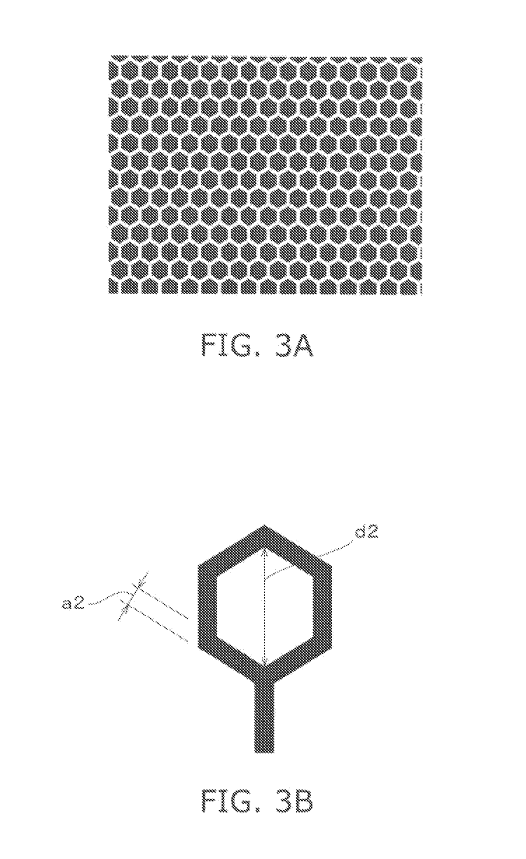

FIG. 3 is a schematic view for illustrating an instance in which the openings 5 have an aperture figure of regular hexagon and are arranged so as to be in the plane filling (honeycomb construction). In the instance as shown in FIG. 3, the diagonal size d2 of the opening 5 is 100 μm, and the space a2 between the adjacent pores is 20 μm. The opening ratio at this time is 85.3%.

Thus, by setting the aperture figure of the openings 5 is to be a regular hexagon and arranging the openings 5 in the plane filling (honeycomb construction), an inorganic material layer 3 having a high opening ratio and strength can be obtained.

The distribution of the openings 5, generally, can be made uniform. However, in case where a fuel cell is operated in such a state that the principal surface of the solid electrolyte membrane 1 is approximately vertical, it is also possible to form so that the distribution state of the openings 5 is denser for upper portions in the vertical direction. In this case, it is also possible to form so that the opening area of the pore of the opening 5 becomes greater for upper portions in the vertical direction. Because, there may be such a case that the after-mentioned reaction in the presence of a catalyst is unequal.

Next, described is the effect on inhibiting the permeation of organic fuel (e.g., methanol crossover) due to the swelling of the porous material layer 2.

When an organic fuel (e.g., methanol) aqueous solution continues to contact to the porous material layer 2, the organic fuel (e.g., methanol) penetrates into the porous material layer 2 to generate the swelling of the porous material layer 2. Then, the generation of the swelling results in the permeation of the organic fuel (e.g., methanol crossover). This is thought to be caused by generation of the size change of the through-holes 4 (pushed to be broadened) in the porous material layer 2 due to the swelling.

When the permeation of organic fuel (e.g., methanol crossover) occurs and the organic fuel (e.g., methanol) arrives on a cathode electrode (air electrode) side, the organic fuel (e.g., methanol) being a fuel is consumed without generating proton (H⁺) and electron (e⁻). Further, it poisons a catalyst, for example, platinum (Pt) on the cathode electrode (air electrode) side to result in the lowering of the catalyst activity, and lower significantly the generating efficiency.

In this Example, the inorganic material layer 3 is formed on the principal surface of the porous material layer 2. Consequently, by inhibiting the expansion that is caused by the swelling of the porous material layer 2 while utilizing the inorganic material layer 3, it is possible to prevent the size change of the through-holes 4, and inhibit the generation of the permeation of organic fuel (e.g., methanol crossover).

The solid electrolyte membrane 1 must have the function of allowing proton (H⁺) to pass through the membrane, in addition to the function of inhibiting the permeation of organic fuel (e.g., methanol crossover). At this time, there is such relation between the sizes of the porous material layer 2 and the inorganic material layer 3 that, in case where the proton (H⁺) conductivity is prioritized, the function of inhibiting the permeation of organic fuel (e.g., methanol crossover) is lowered. Therefore, there is a demand for the size relation of the solid electrolyte membrane 1 (porous material layer 2 and inorganic material layer 3) that takes the function of both layers into consideration. The size relation that is described above satisfies the demand.

In case where a fuel cell is unused, the solid electrolyte membrane 1 dries and contracts. Further, in order to enhance the activity of a catalyst and raise the generating efficiency, the operation temperature of a fuel cell tends to be increased and expansion and contraction due to temperature alteration have tended to be increased. As a result, there is such risk that such trouble as the peeling of a catalyst layer from the solid electrolyte membrane 1 may occur as the result of the stress caused by the expansion and contraction. In the inorganic material layer 3 in this Example, even in such a case, it is possible to inhibit such trouble as the peeling of the catalyst layer and the penetration of organic fuel (e.g., methanol crossover) by preventing the size change of the porous material layer 2.

As described above, according to the present embodiment, such a solid electrolyte membrane that has a high membrane strength and a high generating efficiency by inhibiting the permeation of organic fuel (e.g., methanol crossover) can be obtained.

Next, a second Example of the present embodiment is described.

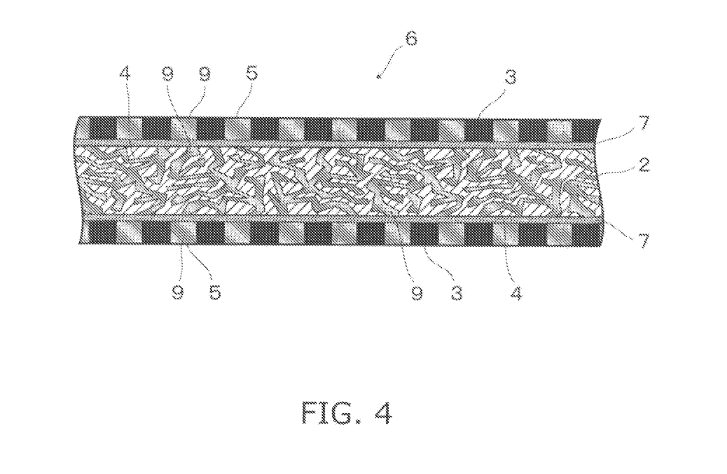

FIG. 4 is a schematic cross-sectional view for illustrating the solid electrolyte membrane according to the second Example of the present embodiment. In a solid electrolyte membrane 6, an electrolyte layer 7 is provided additionally between the porous material layer 2 and the inorganic material layer 3. The porous material layer 2 and the electrolyte layer 7, and the electrolyte layer 7 and the inorganic material layer 3, respectively, are formed so as to adhere to each other. Incidentally, the same parts as those in the solid electrolyte membrane 1 as shown in FIG. 1 are given the same reference letters respectively and the description thereof is omitted.

A poor adhesiveness at the interface of the porous material layer 2 and the inorganic material layer 3 results in the lowering of the proton (H⁺) conductivity to cause the lowering of the generating efficiency. For the purpose of enhancing the adhesiveness, the electrolyte layer 7 is provided.

For the material to be used as the electrolyte layer 7, the proton (H⁺) conductivity and the adhesiveness at the interface must be taken into consideration. The material can be one containing at least a hydroxyl group, a carboxyl group, a sulfone group, an ester group formed by the reaction of at least two types of the carboxyl group and the sulfone group, or an ether group in the skeleton thereof. Specific examples can include those having polytetrafluoroethylene as a main component, polyvinyl sulfonic acid, polystyrene sulfonic acid, and poly(α-methylstyrene) sulfonic acid.

The thickness of the electrolyte layer 7 is preferably 10 μm or less. Because, a thickness greater than 10 μm generates a problem in the proton (H⁺) conductivity.

According to the present Example, as the result of the increase in the adhesiveness at the interface of the porous material layer 2 and the inorganic material layer 3, a solid electrolyte membrane having a high generating efficiency can be obtained.

Next, a third Example of the present embodiment is described.

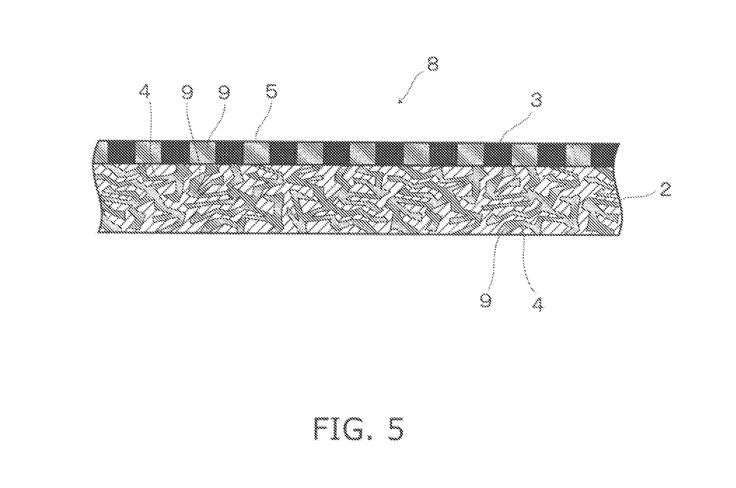

FIG. 5 is a schematic cross-sectional view for illustrating the solid electrolyte membrane according to the third Example of the present embodiment. A solid electrolyte membrane 8 is provided with the porous material layer 2, and the inorganic material layer 3 that is formed on one side of the principal surface thereof. The same parts as those in the solid electrolyte membrane 1 as shown in FIG. 1 are given the same reference letters respectively and the description thereof is omitted.

In order to inhibit the permeation of organic fuel (e.g., methanol crossover), the formation of the inorganic material layer 3 on at least one side of the principal surface of the porous material layer 2 is sufficient. In this case, preferably the surface on which the inorganic material layer 3 is to be formed is selected while taking the generating efficiency of the fuel cell into consideration. For example, in a direct methanol fuel cell, when comparing the catalyst efficiency of a catalyst (e.g., platinum (Pt) and ruthenium (Ru)) on an anode electrode side with a catalyst (e.g., platinum (Pt)) on a cathode electrode side, the catalyst on the anode electrode side has a lower efficiency. Accordingly, it is preferred from the viewpoint of the generating efficiency to keep the principal surface of the porous material layer 2 on the anode electrode side for which the catalyst efficiency is lower in an opened state. In the instance of this example, therefore, preferred is the formation of the inorganic material layer 3 on the principal surface of the cathode electrode side for which the catalyst efficiency is higher.

As described above, in case where the inorganic material layer 3 is formed on one side of the principal surface of the porous material layer 2 while taking the generating efficiency of a fuel cell into consideration, it is advantageous from the viewpoint of the proton (H⁺) conductivity to be able to enhance the generating efficiency as compared with the case where the layer 3 is formed on both sides of the principal surface of the porous material layer 2. But, from the viewpoint of the durability and the change with a lapse of time, it is more preferred to form the inorganic material layer 3 on both sides of the principal surface.

Next, a fourth Example of the present embodiment is described.

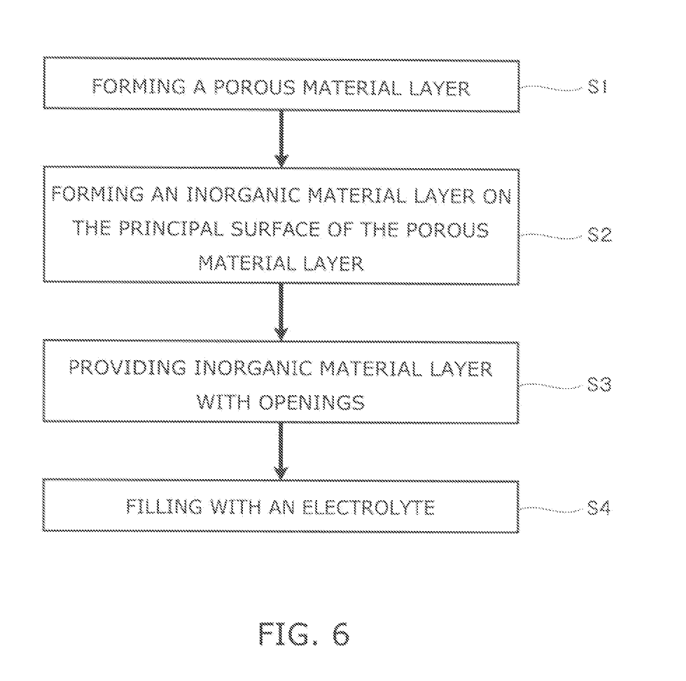

FIG. 6 is a flowchart for illustrating the method of manufacturing the solid electrolyte membrane according to the fourth Example of the present embodiment.

Firstly, the porous material layer 2 is formed using such a chemical or physical method as a phase separation method, a foaming method or a sol-gel method (Step S1). For the porous material layer 2, a commercially available porous material may be used arbitrarily. In this case, the Step S1 is unnecessary. For example, a polyimide porous membrane (UPILEX PT, by UBE INDUSTRIES) having a thickness of 25 μm and an opening ratio of 45% may be employed.

Next, on the principal surface of the porous material layer 2, the inorganic material layer 3 is formed (Step S2). For example, on the polyimide porous membrane, silicon dioxide (SiO₂) film is formed in a thickness of around 0.5 μm. For the film-forming method, a physical film-forming method as represented by a sputtering method, a chemical film-forming method as represented by a CVD (Chemical Vapor Deposition) method can be employed. For example, as a method for forming a silicon dioxide (SiO₂) film, an RF sputtering method can be employed with such film-forming conditions as a target of silicon dioxide (SiO₂), pressure of around 1 Pa, RF power of around 400 W, sputter gas of Ar gas in around 30 sccm, and porous material layer temperature of around 40° C.

Here, the inorganic material layer 3 is preferably so formed that it adheres to the porous material layer 2. Because, a poor adhesiveness at the interface of the porous material layer 2 and the inorganic material layer 3 lowers the proton (H⁺) conductivity to result in causing the lowering in the generating efficiency. As described above, therefore, the electrolyte layer 7 may be formed between the porous material layer 2 and the inorganic material layer 3. For the electrolyte layer 7, for example, Nafion (registered trade mark, by DuPont) can be cited. The electrolyte layer 7 can be formed on the principal surface of the porous material layer 2 according to such a formation method as dipping the porous material layer 2 in a Nafion (registered trade mark, by DuPont) solution and then pulling out and drying the same to remove the solvent. In this case, the method is so designed that an electrolyte 9 having the same material quality as the electrolyte layer 7 is filled into the after-mentioned through-holes 4 in the porous material layer 2 when forming the electrolyte layer 7.

By providing the electrolyte layer 7, the adhesiveness between the porous material layer 2 and the inorganic material layer 3 can be enhanced. As the result, the proton (H⁺) conductivity can be enhanced to improve the generating efficiency.

Even in case where the electrolyte layer 7 is not provided, it is preferred to carry out a surface modification treatment of the porous material layer 2 in order to improve the adhesiveness between the porous material layer 2 and the inorganic material layer 3. For example, in case where the porous material layer 2 is composed of an organic material, and such oxide as silicon dioxide (SiO₂) is selected for the inorganic material layer 3, such treatment that makes the surface of the porous material layer 2 hydrophilic is preferred. For the modification treatment method in this case, a surface modification method by the irradiation of ultraviolet light from an excimer lamp can be exemplified. In particular, since vacuum-ultraviolet light at a wavelength of 172 nm that is generated by an excimer lamp has a high photon energy and can irradiate a large area, it can enhance the efficiency of the modification treatment. Incidentally, the surface modification treatment is preferably carried out in case where the aforementioned electrolyte layer 7 is provided.

The practice of such surface modification treatment can improve the adhesiveness between the porous material layer 2 and the inorganic material layer 3. As the result, the proton (H⁺) conductivity can be enhanced, and thus the generating efficiency can be improved.

Next, the openings 5 are provided for the inorganic material layer 3 (Step S3). As the method for providing the openings 5, a dry etching method or a wet etching method can be employed. An instance in which a wet etching method is used is exemplified here. Firstly, on the inorganic material layer 3, an ultraviolet-curable resin is spin-coated in a thickness of around several tens μm, which is then baked, exposed, developed and post-baked to form the pattern of the openings 5. After that, by carrying out etching with a buffered hydrofluoric acid and removing the resist with a stripping solution, an intended openings 5 can be provided for the inorganic material layer 3.

Next, the through-holes 4 in the porous material layer 2 and the openings 5 in the inorganic material layer 3 are filled with the electrolyte 9 (Step S4). For the method of the filling of the electrolyte 9, a method, in which the porous material layer 2 and the inorganic material layer 3 are dipped in an electrolyte, which are pulled out and dried to remove the solvent, can be exemplified. On this occasion, the dipping and the drying are to be repeated for several times. For the solvent of the electrolyte solution, water with surfactant, an organic solvent, or a mixed solution thereof is employed. Of these, the solvent must be able to dissolve or disperse stably the electrolyte 9. For the electrolyte solution, a Nafion (registered trade mark, by DuPont) solution can be exemplified.

Next, a fifth Example of the present embodiment is described.

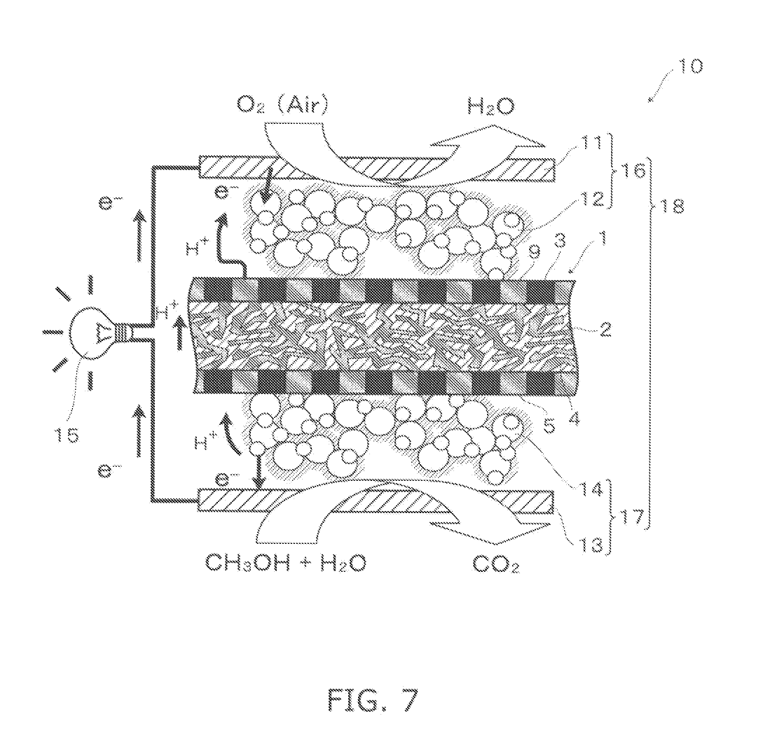

FIG. 7 is a schematic view for illustrating the fuel cell according to the fifth Example of the present embodiment. For the sake of simplicity, the description will be given on the basis of a direct methanol fuel cell (DMFC) that uses methanol as the fuel.

As shown in FIG. 7, a fuel cell 10 is provided with a membrane electrode assembly (MEA) 18 that is disposed with the solid electrolyte membrane 1 as described in FIG. 1, a cathode electrode 16 and an anode electrode 17. The membrane electrode assembly 18 is housed in a case (not shown). For the solid electrolyte membrane, one described in FIG. 4 or FIG. 5 may be employed.

The solid electrolyte membrane 1 is provided with the porous material layer 2, and the inorganic material layer 3 that is formed on the principal surface thereof, as described above. And there is provided the through-holes 4 in a labyrinth figure to the porous material layer 2, and the openings 5 to the inorganic material layer 3. The through-holes 4 and the openings 5 are filled with the electrolyte 9.

As a specific example, the porous material layer 2 may be constituted of a polyimide porous membrane having a thickness of 25 μm and an opening ratio of 45%, and the inorganic material layer 3 may be constituted of silicon dioxide (SiO₂) having a thickness of around 0.5 μm. The material of the electrolyte 9 may be Nafion (registered trade mark, by DuPont). The openings 5 may be so formed, as shown in FIG. 3, that the aperture figure thereof is a regular hexagon to be arranged in plane filling (honeycomb construction). As a specific example, the openings 5 may have a diagonal size of 100 μm and the space of 20 μm between adjacent pores. The pore diameter of the through-holes 4 may be around 1 μm.

For a current collector 11 of the cathode electrode 16, a porous carbon woven fabric or carbon paper (content of PTFE (Polytetrafluoroethylene) is around 5% by weight) having been subjected to a water-repellent treatment of impregnating a PTFE solution can be employed. For the catalyst 12 of the cathode electrode 16, one having fine particles of platinum (Pt) that are supported on a granular or fibrous carbon such as activated carbon or graphite can be employed. In this case, the content of platinum (Pt) in the catalyst is preferably around from 10% by weight to 70% by weight.

For the current collector 13 of the anode electrode 17, a porous carbon woven fabric or carbon paper (content of PTFE is around 5% by weight) having been subjected to a water-repellent treatment of impregnating a PTFE (Polytetrafluoroethylene) solution can be employed. For the catalyst 14 of the anode electrode, one having fine particles of platinum (Pt)-ruthenium (Ru) that are supported on a granular or fibrous carbon such as activated carbon or graphite can be employed. In this case, the total content of platinum (Pt) and ruthenium (Ru) in the catalyst is preferably around from 10% by weight to 70% by weight. For the weight ratio of platinum (Pt) to ruthenium (Ru), platinum (Pt):ruthenium (Ru) is preferably around from 5:1 to 1:2. The current collector 11 and the current collector 13 are connected electrically with a load 15.

In addition, on the cathode electrode 16 side, a plurality of air vents are provided for supplying air (oxygen: O₂) or discharging generated water as water vapor, although the drawing thereof is omitted. On the anode electrode 17 side, provided are a fuel-supplying port for supplying fuel (methanol aqueous solution) and a fuel vent for discharging residual fuel (methanol aqueous solution) or carbon dioxide (CO₂) that has been generated through the reaction.

The material, size, cross-sectional figure, aperture figure, arrangement, component ratio and the like that are shown as specific examples are not limited to these, but they can be changed arbitrarily.

Next, the action of a fuel cell 10 is described.

When a methanol aqueous solution being fuel is supplied from a fuel-supplying port to the anode electrode 17 side, there occurs an oxidation reaction of the methanol aqueous solution that is represented by the following formula (1) in the presence of the catalyst 14 of the anode electrode 17. As the result of this reaction, carbon dioxide CO₂, proton (H⁺) and electron (e⁻) are generated. The proton (H⁺) permeates through the solid electrolyte membrane 1 and moves to the cathode electrode 16 side. The electron (e⁻) performs work while passing through the load 15 and then moves to the cathode electrode 16 side.

CH₃OH+H₂O→CO₂+6H⁺+6e⁻ (1)

The proton (H⁺) that has reached the cathode electrode 16 side, the electron (e⁻) that has reached the cathode electrode 16 side after performing work while passing through the load 15, and oxygen O₂ in air produce the reduction reaction that is represented by the formula (2) in the presence of the catalyst 12 of the cathode electrode 16.

6H⁺+6e⁻+3/2O₂→3H₂O (2)

The carbon dioxide (CO₂) that is produced on the anode electrode 17 side is discharged from the fuel vent to the outside with a residual methanol aqueous solution. The water that is produced on the cathode electrode 16 side is discharged from the air vent as vapor.

The fuel cell according to the present Example is provided with the aforementioned solid electrolyte membrane. Consequently, according to the present Example, a fuel cell that has a high membrane strength and a high generating efficiency by inhibiting the permeation of organic fuel (e.g., methanol crossover) can be obtained.

Next, the method of manufacturing a fuel cell according to a sixth Example of the present embodiment is described.

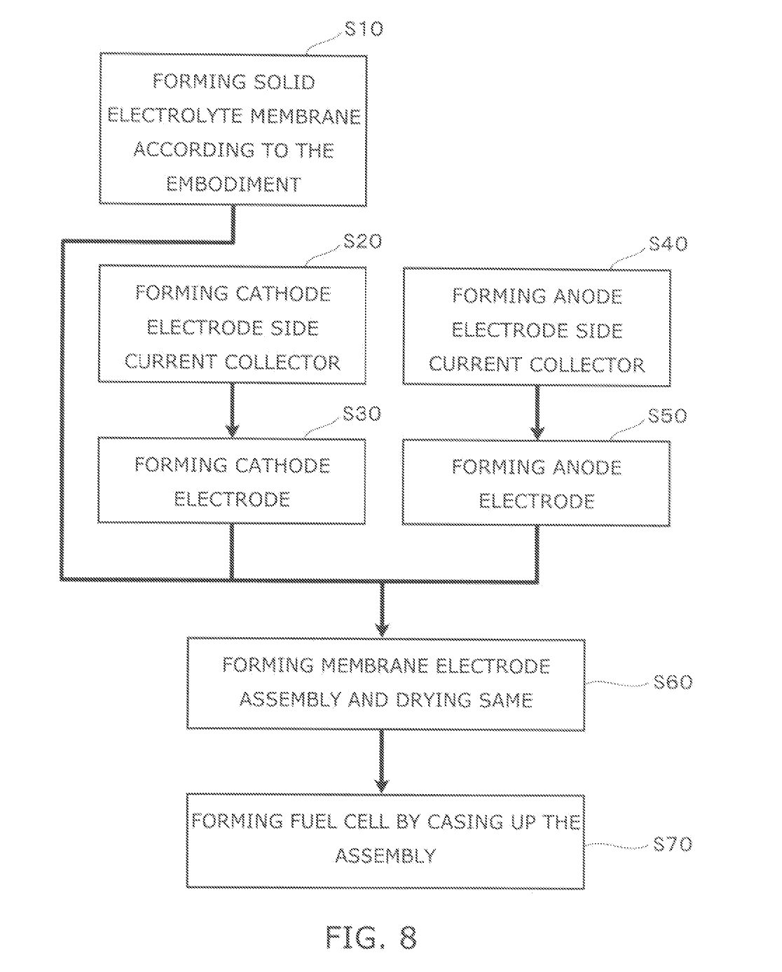

FIG. 8 is a flowchart for illustrating the method of manufacturing a fuel cell according to the sixth Example of the present embodiment.

The solid electrolyte membrane 1 according to the embodiment is formed by the aforementioned method (Step S10). The solid electrolyte membrane may be one that is described for FIG. 4 or FIG. 5.

A porous carbon woven fabric or carbon paper is impregnated with a PTFE (Polytetrafluoroethylene) solution to form the current collector 11 on the cathode electrode 16 side (Step S20). In this occasion, the PTFE content is determined to around 5% by weight.

Next, fine particles of platinum (Pt), granular or fibrous carbon of activated carbon or graphite, and a solvent are mixed to be pasty, which is coated on the current collector 11 to be used as the catalyst 12, thereby forming the cathode electrode 16 (Step S30). In this occasion, the platinum (Pt) content in the catalyst 12 is preferably around from 10% by weight to 70% by weight.

On the other hand, a porous carbon woven fabric or carbon paper is impregnated with a PTFE (Polytetrafluoroethylene) solution to form the current collector 13 on the anode electrode 17 side (Step S40). In this occasion, the PTFE content is determined to around 5% by weight.

Next, fine particles of platinum (Pt)-ruthenium (Ru), granular or fibrous carbon of activated carbon or graphite, and a solvent are mixed to be pasty, which is coated on the current collector 13 to be used as the catalyst 14, thereby forming the cathode electrode 17 (Step S50). In this occasion, the total content of the platinum (Pt) and the ruthenium (Ru) in the catalyst 14 is preferably around from 10% by weight to 70% by weight. For the weight ratio of the platinum (Pt) to the ruthenium (Ru), preferably platinum (Pt):ruthenium (Ru) is around from 5:1 to 1:2.

Next, the solid electrolyte membrane 1, the cathode electrode 16 and the anode electrode 17 thus formed are used for forming the membrane electrode assembly 18, which is dried (Step S60). In this occasion, the drying is preferably carried out in such an inert gas as nitrogen or argon (Ar), or in vacuum.

Finally, it is housed in a case arbitrarily to form the fuel cell 10 (Step S70).

### Second Embodiment

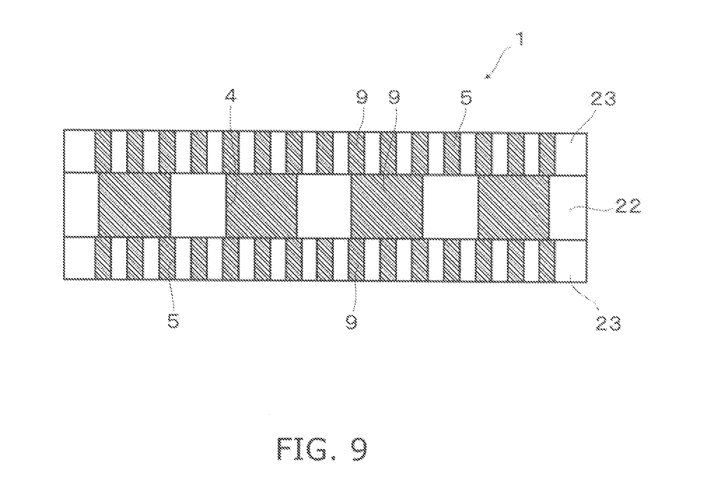

FIG. 9 is a schematic cross-sectional view for illustrating the solid electrolyte membrane according to the second embodiment of the present invention. The solid electrolyte membrane 1 is provided with a first porous layer 22 and second porous layers 23 formed on both sides of the principal surface thereof. In the first porous layer 22, there are provided through-holes 4 in a labyrinth figure, and in the second porous layers 23, there are provided openings 5. The through-hole 4 and the opening 5 are filled with an electrolyte 9.

The first porous layer 22 has such function as the proton (H⁺) conduction and inhibiting the permeation of organic fuel (e.g., methanol crossover). A second porous layer 23 has such function as inhibiting the electrolyte 9 that has been filled into the first porous layer 22 from being detached through contraction caused by drying, as described later.

Here, the through-holes 4 and the openings 5 are formed in a straight pore. The reason for forming a straight pore is to think much of the proton (H⁺) conductivity. Either the through-holes 4 or the openings 5 may be formed to be a pore in a labyrinth figure (e.g., pore of porous material). Because, a labyrinth figure results in enhancing the effect on inhibiting the permeation of organic fuel (e.g., methanol crossover).

In particular, by forming the openings 5 in a pore of a labyrinth figure, the effect on inhibiting the electrolyte 9 that has been filled into the first porous layer 22 from being detached through contraction caused by drying can be enhanced.

In case where the both are formed in a labyrinth figure, there may occur trouble in the proton (H⁺) conductivity as the entire solid electrolyte membrane 1.

The first porous layer 22 and the second porous layers 23 can be constituted of a heat-resistant organic material, inorganic material, or composite material thereof.

Specifically, examples of the organic material include polyethylene, polypropylene, polyimide, polyamide, polyetherimide, polyether ether ketone, polytetrafluoroethylene, tetrafluoroethylene-ethylene copolymer, tetrafluoroethylene-propylene copolymer, tetrafluoroethylene-hexafluoropropylene copolymer, polyvinylidene fluoride, tetrafluoroethylene-perfluoroalkoxyethylene copolymer, polysulfone, polyphenylene sulfide, polyarylate, polyether sulfone, polysilazane; examples of the inorganic material include silicon oxide, silicon carbide, silicon nitride, alumina, zirconium oxide, ceria, lead oxide, bismuth oxide, boron oxide; and the examples of the composite material include polypropylene compositely immixed with glass fiber or organic fiber.

Of these, the first porous layer 22 is more preferably constituted of an organic material or a composite material, because an organic material or a composite material makes it possible to form a thinner solid electrolyte membrane 1 to result in the advantage for the proton (H⁺) conduction. In addition, because an organic material and a composite material abound in flexibility, have resistance to a break and a crack, and are suitable for miniaturization.

For a method of providing these materials with straight pores, a dry etching method or a wet etching method can be employed. For a method of providing these materials with pores in a labyrinth figure, publicly known such chemical or physical methods as a phase separation method, a foaming method and a sol-gel method can be employed. Or, such a porous organosilicon compound as polysilazane and such a porous inorganic material as ceramics can be also used directly.

The material of the electrolyte 9 to be filled into the through-holes 4 and the openings 5 can be one having a hydroxyl group, a carboxyl group, a sulfone group, an ester group formed by the reaction of at least two types of the carboxyl group and the sulfone group, or ether group in the skeleton thereof. Specific examples include ones having polytetrafluoroethylene as a main component, polyvinyl sulfonic acid, polystyrene sulfonic acid and poly(a-methylstyrene) sulfonic acid. A method for filling the material into the through-holes 4 and the openings 5 is described later.

The thickness of the first porous layer 22 is preferably from 0.01 μm to 100 μm. A thickness of smaller than 0.01 μm results in a too low strength as the solid electrolyte membrane 1, and a thickness of greater than 100 μm results in a too long passing distance of proton (H⁺) to give rise to a problem in the conductivity of the proton. In this case, the thickness is more preferably from 10 μm to 30 μm while thinking much of the proton (H⁺) conductivity.

In case where, for example, the first porous layer 22 is formed from an organic material alone, a preferred thickness is around 10 μm or greater while taking the easiness of the production and the handling into consideration. But, in case where it is formed from an inorganic material alone or a composite material, the thickness can be made smaller than 10 μm.

The pore diameter of the through-holes 4 in the first porous layer 22 is preferably from 10 μm to 200 μm. Because, a diameter smaller than 10 μm may generate a problem in the proton (H⁺) conductivity, and a diameter greater than 200 μm may result in a shortage of the strength itself of the first porous layer 22. The pore diameter is an average diameter when the aperture figure of the through-holes 4 is converted to a circle.

The opening ratio of the through-holes 4 in the first porous layer 22 is preferably from 20% to 90%. Because, the ratio smaller than 20% generates trouble in the proton (H⁺) conductivity, and the ratio greater than 90% results in a shortage of the mechanical strength itself of the first porous layer 22. In this occasion, the ratio is more preferably from 40% to 70% while thinking much of the mechanical strength.

The thickness of the second porous layer 23 is preferably from 0.01 μm to 200 μm. Because, when the thickness is smaller than 0.01 μm, the mechanical strength of the second porous layer 23 is lowered. When the thickness is greater than 200 μm, a passing distance of proton (H⁺) is lengthened to give rise to a problem in the proton (H⁺) conductivity. In this case, for example, while thinking much of the mechanical strength of the second porous layer 23, the thickness is more preferably from 0.5 μm to 10 μm.

The pore diameter of the openings 5 in the second porous layer 23 is preferably from 0.1 μm to 200 μm. Because, the diameter smaller than 0.1 μm generates trouble in the proton (H⁺) conductivity, and the diameter greater than 200 μm results in a shortage of the mechanical strength itself of the first porous layer 23. When taking the easiness of processing into consideration, the diameter of around 50 μm is also possible.

Further, when also taking the effect on inhibiting the electrolyte 9 that has been filled into the first porous layer 22 from being detached through contraction caused by drying into consideration, the diameter is more preferably from 0.1 μm to 10 μm.

The pore diameter is an average diameter when the aperture figure of the openings 5 is converted to a circle.

The opening ratio of the openings 5 in the second porous layer 23 is preferably from 20% to 90%. Because, when the ratio is smaller than 20%, there occurs a problem in the proton (H⁺) conductivity; and when the ratio is greater than 90%, the mechanical strength itself of the second porous layer 23 is lowered. In this case, while thinking much of the proton (H⁺) conductivity, the ratio is more preferably from 40% to 70%.

The ratio of the pore diameter of the openings 5 in the second porous layer 23 to the thickness of the second porous layer 23 (the pore diameter of the opening 5 in the second porous layer/the thickness of the second porous layer 23) is preferably 100 or less while taking the balance of the proton (H⁺) conductivity and the mechanical strength of the second porous layer 23 into consideration. Further, when taking the effect on inhibiting the electrolyte 9 that has been filled into the first porous layer 22 from being detached through contraction caused by drying while securing the proton (H⁺) conductivity into consideration, the ratio is more preferably 1 or less.

Next, the relation between the through-hole 4 in the first porous layer 22 and the opening 5 in the second porous layer 23 is described.

As described later, there may be a case where the electrolyte 9 that has been filled into the first porous layer 22 is detached through contraction caused by drying. In this occasion, by selecting suitably the size of the opening 5 in the second porous layer 23, it is possible to inhibit the electrolyte 9 that has been filled into the first porous layer 22 from being detached.

That is, by setting the average diameter d2 of the openings 5 to be smaller than the average diameter d1 of the through-holes 4, the detachment of the electrolyte 9 can be inhibited.

Furthermore, by so selecting the size of the openings 5 that, when denoting the swelling percentage of the electrolyte 9 as a, the average diameter of the through-holes 4 as d1 and the average diameter of the openings 5 as d2, the formula d1/(1+a)>d2 is satisfied, it is possible to inhibit substantially completely the detachment of the electrolyte 9 that has been filled into the first porous layer 22 through contraction caused by drying.

Because, in case where the second porous layer 23 having such size of the openings 5 is provided on the principal surface of the first porous layer 22, even when the diameter size of the electrolyte 9 that has been filled is down to d1/(1+a) through contraction, the detachment of the electrolyte 9 can be inhibited by the second porous layer 23.

Next, the aperture figure of the through-holes 4 in the first porous layer 22 and the openings 5 in the second porous layer 23, and the arrangement thereof are described.

A “circular” aperture figure of the through-holes 4 and the openings 5 can reduce the stress concentration and inhibit the lowering in the strength of the first porous layer 22 and the second porous layers 23 caused by the existence of the pore. An “angular” aperture figure of the through-holes 4 and the openings 5 allows the opening ratio to be increased as compared with the case of “circular” one because the space between the adjacent pores can be used effectively. In case where the “angular” figure is a regular polygon capable of attaining the plane filling (regular triangle, regular tetragon, regular hexagon), the opening ratio can be made highest. The through-holes 4 and the openings 5 can be so arranged that they are in a reticular pattern, or in the plane filling. In particular, in case where regular hexagons are arranged so as to be in the plane filling (honeycomb construction), the opening ratio can be made highest while minimizing the lowering of the strength of the first porous layer 22 and the second porous layers 23 caused by the existence of the pores.

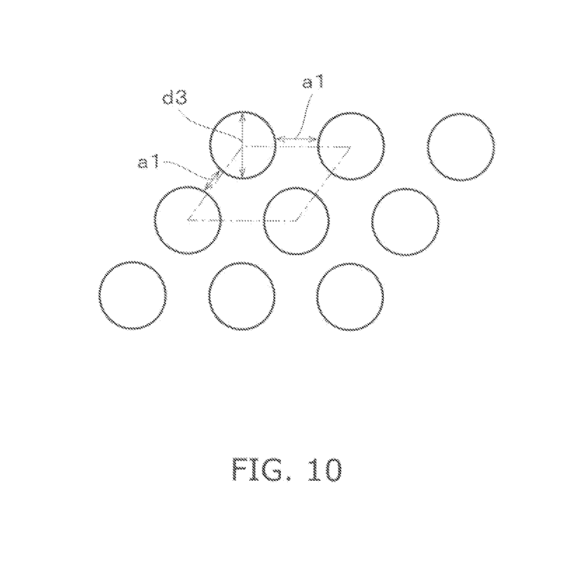

FIG. 10 is a schematic view for illustrating an instance in which the through-holes 4 and the openings 5 are formed to have a circular aperture figure and arranged in a zigzag shape. In the instance as shown in FIG. 10, the diameter d3 of the through-holes 4 and the opening 5 is 10 μm, and the space a1 between the adjacent pores is 2 μm. The opening ratio at this time is 63.9%. When the space a1 is 3 μm, the opening ratio is 53.4%.

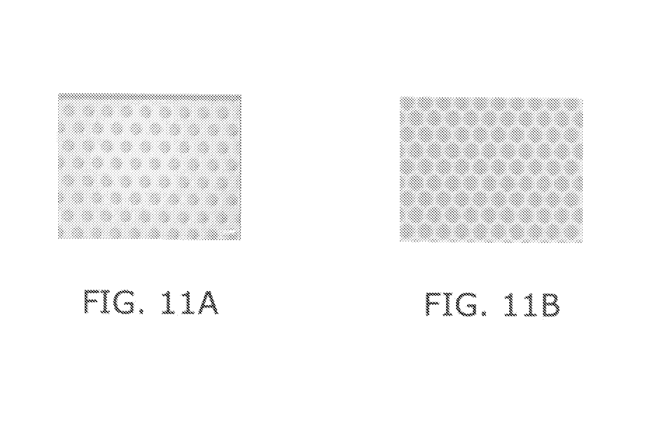

FIG. 11 is a schematic view for illustrating the aperture figure and the opening ratio of the through-holes 4 and the openings 5.

In case where the aperture figure of the through-holes 4 and the openings 5 is “circular” as shown in FIG. 11A, the opening ratio is 23%, but in case where the aperture figure of the through-holes 4 and the openings 5 is “regular hexagonal” as shown in FIG. 11B, the opening ratio can be 46%.

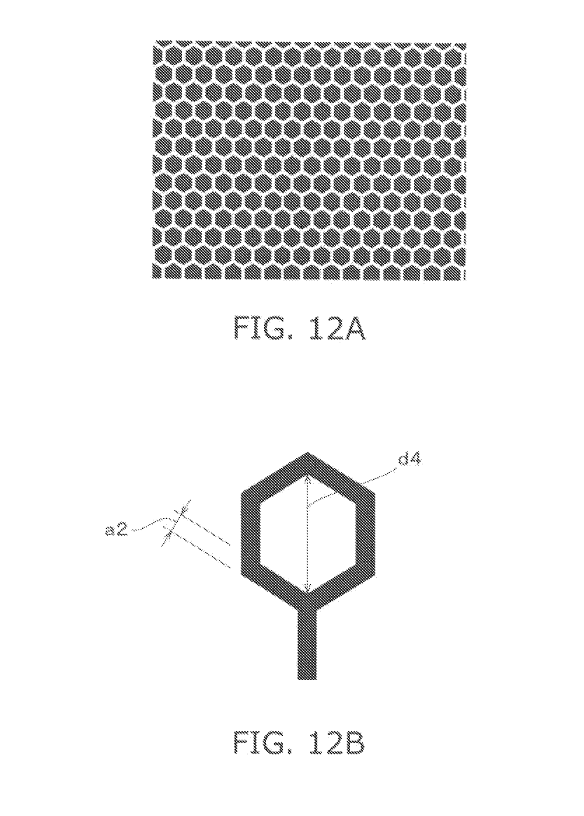

FIG. 12 is a schematic view for illustrating the instance in which the through-holes 4 and the openings 5 have the aperture figure of a regular hexagon and they are arranged in the plane filling (honeycomb construction).

FIG. 12A is a schematic view for illustrating the appearance when regular hexagonal through-holes 4 and openings 5 are arranged in the plane filling (honeycomb construction). FIG. 12B is a schematic extended drawing of the aperture portion of the through-holes 4 and the openings 5.

As shown in FIG. 12B, by setting the diagonal size d4 of the through-holes 4 and the openings 5 to 100 μm and the space a2 between the adjacent pores to 20 μm, the opening ratio can be made 85.3%.

Thus, by making the aperture figure of the through-holes 4 and the openings 5 regular hexagonal to realize the plane filling (honeycomb construction), a first porous layer 22 and a second porous layer 23 having a high opening ratio and strength can be obtained.

For the distribution of the through-holes 4 and the openings 5, uniform distribution can be adopted in general. However, in case where a fuel cell is operated in such a state that the principal surface of the solid electrolyte membrane 1 stands approximately vertical, it is also possible to distribute the through-holes 4 and the openings 5 so that the density thereof is higher in the vertically upper portions. On this occasion, it is also possible to make the aperture area of the pore of the through-holes 4 and the openings 5 greater in the vertically upper portions. Because, or else, the after-mentioned catalyzed reaction may occur unevenly.

Next, the effect on inhibiting the detachment of the electrolyte 9 that has been filled in the first porous layer 22 through contraction caused by drying is described.

In the after-mentioned production process of the solid electrolyte membrane 1, on evaporating to remove the solvent that has been used for the filling of the electrolyte 9, the electrolyte 9 is dried to contract. Further, when a fuel cell is unused also, the electrolyte 9 may be dried to contract.

And when such contraction occurs, the detachment of the electrolyte 9 from the first porous layer 22 may occur.

If a first porous layer 22 from which the electrolyte 9 had been detached were used for a fuel cell, then the permeation of organic fuel (e.g., methanol crossover) would occur and the organic fuel (e.g., methanol) would reach the cathode electrode (air electrode) side. In that event, the organic fuel (e.g., methanol) being fuel would be consumed without generating proton (H⁺) and electron (e⁻), and poison the catalyst on the cathode electrode (air electrode) side, for example, platinum (Pt) even to result in the lowering of the catalyst activity to lower significantly the generating efficiency.

In the present embodiment, on the principal surface of the first porous layer 22, provided is the second porous layer 23 having the openings 5 with the aforementioned relation in the size. Therefore, the second porous layer 23 can inhibit the detachment of the electrolyte 9 that has been filled in the first porous layer 22, even when the electrolyte contracts. Consequently, the generation of the permeation of organic fuel (e.g., methanol crossover) can be inhibited.

The solid electrolyte membrane 1 must have the function of allowing proton (H⁺) to pass through the membrane, in addition to the function of inhibiting the permeation of organic fuel (e.g., methanol crossover). On this occasion, for the relation of sizes of the through-holes 4 and the openings 5, when priority is given to the proton (H⁺) conductivity, the function of inhibiting the detachment of the electrolyte 9 lowers. Consequently, such relation of the size of the solid electrolyte membrane 1 (through-holes 4 and openings 5) that takes both functions into consideration is necessary. The size relation that is described above satisfies the demand.

As described above, according to the present embodiment, such solid electrolyte membrane can be obtained that is excellent in the membrane strength and generating efficiency, and in addition, can inhibit the detachment of the electrolyte caused by drying.

Next, a second Example of the present embodiment is described.

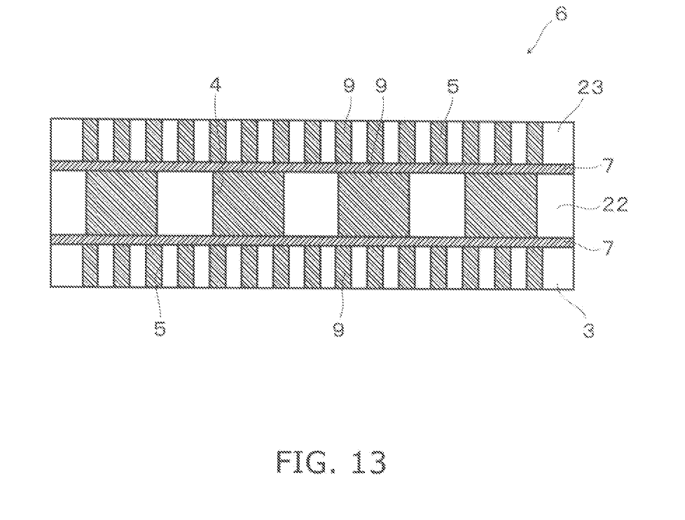

FIG. 13 is a schematic cross-sectional view for illustrating the solid electrolyte membrane according to the second Example of the present embodiment. In a solid electrolyte membrane 6, an electrolyte layer 7 is provided additionally between the first porous layer 22 and the second porous layer 23. The first porous layer 22 and the electrolyte layer 7, and the electrolyte layer 7 and the second porous layer 23, respectively, are formed so as to adhere to each other. Incidentally, the same parts as those in the solid electrolyte membrane 1 as shown in FIG. 1 are given the same reference letters respectively and the description thereof is omitted.

A poor adhesiveness at the interface of the first porous layer 22 and the second porous layer 23 results in the lowering of the proton (H⁺) conductivity to cause the lowering of the generating efficiency. For the purpose of enhancing the adhesiveness, the electrolyte layer 7 is provided.

For the material to be used as the electrolyte layer 7, the proton (H⁺) conductivity and the adhesiveness at the interface must be taken into consideration. The material can be one containing at least a hydroxyl group, a carboxyl group, a sulfone group, an ester group formed by the reaction of at least two types of the carboxyl group and the sulfone group, or an ether group in the skeleton thereof. Specific examples can include those having polytetrafluoroethylene as a main component, polyvinyl sulfonic acid, polystyrene sulfonic acid, and poly(α-methylstyrene) sulfonic acid.

The thickness of the electrolyte layer 7 is preferably 10 μm or less. Because, a thickness greater than 10 μm generates a problem in the proton (H⁺) conductivity.

According to the present Example, as the result of the increase in the adhesiveness at the interface of the first porous layer 22 and the second porous layer 23, a solid electrolyte membrane having a high generating efficiency can be obtained.

Next, a third Example of the present embodiment is described.

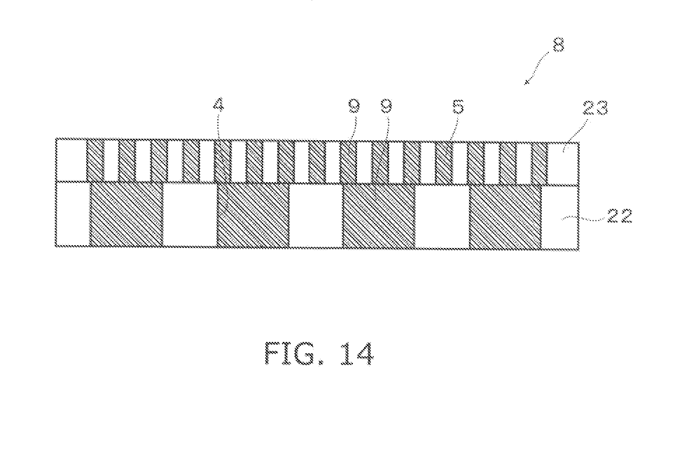

FIG. 14 is a schematic cross-sectional view for illustrating the solid electrolyte membrane according to the third Example of the present embodiment. A solid electrolyte membrane 8 is provided with the first porous layer 22, and the second porous layer 23 that is formed on one side of the principal surface thereof. The same parts as those in the solid electrolyte membrane 1 as shown in FIG. 1 are given the same reference letters respectively and the description thereof is omitted.

As shown in FIG. 14, it is also possible to provide the second porous layer 23 on at least one side of the principal surface of the first porous layer 22. By providing the second porous layer 23 on one side alone, it is possible to enhance the proton (H⁺) conductivity to improve the generating efficiency of the fuel cell, although the risk of detachment of the electrolyte 9 is enhanced.

In this case, preferably the surface on which the second porous layer 23 is to be formed is selected while taking the generating efficiency of the fuel cell into consideration. For example, in a direct methanol fuel cell, when comparing the catalyst efficiency of a catalyst (e.g., platinum (Pt) and ruthenium (Ru)) on an anode electrode side with a catalyst (e.g., platinum (Pt)) on a cathode electrode side, the catalyst on the anode electrode side has a lower efficiency. Accordingly, it is preferred from the viewpoint of the generating efficiency to keep the principal surface of the first porous layer 22 on the anode electrode side for which the catalyst efficiency is lower in an opened state. In the instance of this example, therefore, preferred is the formation of the second porous layer 23 on the principal surface of the cathode electrode side for which the catalyst efficiency is higher.

As described above, in case where the second porous layer 23 is formed on one side of the principal surface of the first porous layer 22 while taking the generating efficiency of a fuel cell into consideration, it is advantageous from the viewpoint of the proton (H⁺) conductivity to be able to enhance the generating efficiency as compared with the case where the layer 23 is formed on both sides of the principal surface of the first porous layer 22. But, from the viewpoint of the durability and the change with a lapse of time, it is more preferred to form the second porous layer 23 on both sides of the principal surface.

Next, a fourth Example of the present embodiment is described.

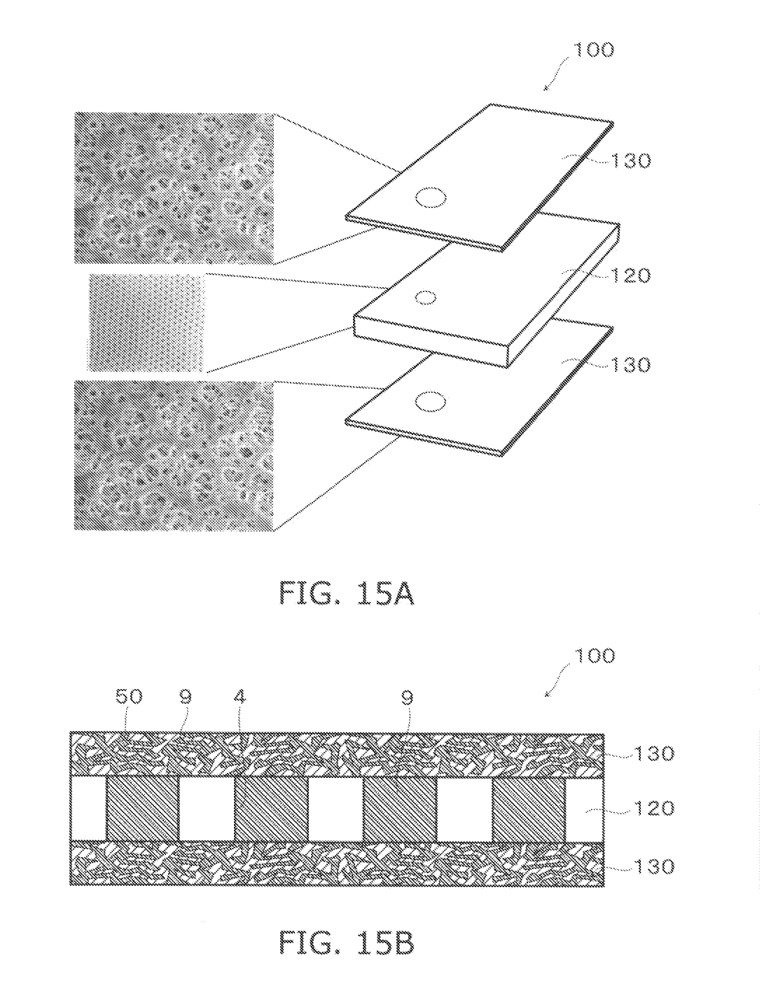

FIG. 15 is a schematic view for illustrating the solid electrolyte membrane according to the fourth Example of the present embodiment.

FIG. 15 A is a schematic exploded drawing of a solid electrolyte membrane 100, and FIG. 15B is a schematic cross-sectional view of the solid electrolyte membrane 100.

As shown in FIG. 15 A, the solid electrolyte membrane 100 is provided with a first porous layer 120, and a second porous layer 130 provided on the principal surface thereof. Incidentally, the same parts as those in the solid electrolyte membrane 1 as shown in FIG. 1 are given the same reference letters respectively and the description thereof is omitted.

When comparing the solid electrolyte membrane 100 with the solid electrolyte membrane 1 as shown in FIG. 1, the opening portion of the second porous layer 130 has a different figure. That is, it is different from the instance of the second porous layer 23 in that the second porous layer 130 has labyrinth-like openings 50. Incidentally, the first porous layer 120 has straight through-holes 4 as is the case for the first porous layer 22.

By forming the openings 50 in a labyrinth-like pore, it is possible to enhance further the effect on inhibiting the detachment of the electrolyte 9 that has been filled in the first porous layer 120 through contraction caused by drying.

Next, a fifth Example of the present embodiment is described.

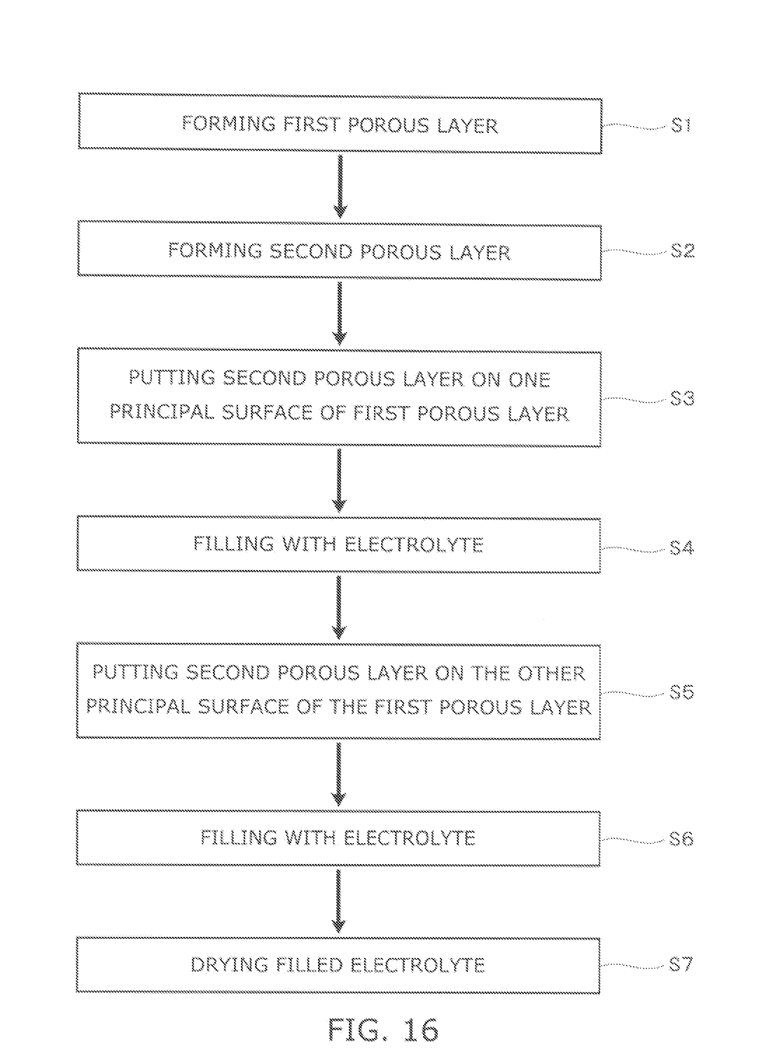

FIG. 16 is a flowchart for illustrating the method of manufacturing the solid electrolyte membrane according to the fifth Example of the present embodiment. As a matter of convenience of description, the instance of the solid electrolyte membrane 1 that is described mainly for FIG. 1 is described.

Firstly, such a chemical or physical method as a wet etching method or a dry etching method is used for forming the first porous layer 22 having straight through-holes 4 with an intended size (Step S1).

Here, an instance that uses a wet etching method is exemplified. Firstly, on a material having a predetermined size that is to be the first porous layer 22, ultraviolet-curable resin is spin-coated in a thickness of around several tens μm, which is baked, exposed, developed and post-baked to form the pattern for the through-holes 4. Then, by carrying out etching with buffered hydrofluoric acid, and removing the resist with a stripping solution, the first porous layer 22 having intended through-holes 4 can be formed.

In case where the first porous layer 22 having labyrinth-like openings is to be formed, such a chemical or physical method as a phase separation method, a foaming method or a sol-gel method can be employed to form the first porous layer 22.

On this occasion, a commercially available porous material may be used directly. In that case, the Step 1 is unnecessary. For a material having labyrinth-like openings, for example, a polyimide porous membrane (UPILEX PT, by UBE INDUSTRIES) having a thickness of 25 μm and an opening ratio of 45% can be employed.

Next, by using such a chemical or physical method as a wet etching method or a dry etching method, the second porous layer 23 having straight openings 5 with the aforementioned relation of the size is formed (Step S2).

Here, an instance that uses a wet etching method is exemplified. Firstly, on a material having a predetermined size that is to be the second porous layer 23, ultraviolet-curable resin is spin-coated in a thickness of around several tens μm, which is baked, exposed, developed and post-baked to form the pattern for the openings 5. Then, by carrying out etching with buffered hydrofluoric acid, and removing the resist with a stripping solution, the second porous layer 23 having intended openings 5 can be formed.

Incidentally, a second porous layer 23 having labyrinth-like openings may be formed in the same way as that for the aforementioned first porous layer 22.

Next, the second porous layer 23 is put on one side of the principal surface of the first porous layer 22 (Step S3).

Next, the first porous layer 22 with the second porous layer 23 that has been put on one side of the principal surface thereof is filled with the electrolyte 9 having been dissolved in a solvent (Step S4). On this occasion, the filling is practiced preferably from the side on which the second porous layer 23 is not put, because the resistance against the filling is lower.

For the solvent of the electrolyte solution, water with surfactant, an organic solvent, or mixed solution thereof is used. On this occasion, it must be able to dissolve or disperse stably the electrolyte 9. For the electrolyte solution, a Nafion (registered trade mark, by DuPont) solution can be exemplified.

Next, on the other principal surface of the first porous layer 22, the second porous layer 23 is put (Step S5).

Next, the first porous layer 22 with the second porous layers 23 that have been put on both sides of the principal surface thereof is filled with the electrolyte 9 having been dissolved in a solvent (Step S6).

Next, the first porous layer 22 and the second porous layer 23 that have been filled with the electrolyte 9 are dried to form the solid electrolyte membrane 1 (Step S7). Through the drying of the electrolyte 9, the first porous layer 22 and the second porous layer 23 are integrated to form the solid electrolyte membrane 1.

On this occasion, since the second porous layer 23 having the openings 5 with the aforementioned relation of the size is provided on the principal surface of the first porous layer 22, the second porous layers 23 serve to inhibit the detachment of the electrolyte 9 that has been filled into the first porous layer 22 even when the electrolyte contracts caused by drying. Incidentally, labyrinth-like openings of the second porous layer 23 can enhance further the inhibitory function for the detachment.

It is also possible to put the second porous layers 23 on both principal surfaces of the first porous layer 22 in Step S3, and to fill the electrolyte 9 that has been dissolved in a solvent into the first porous layer 22 with the second porous layers 23 that have been put on both principal surface thereof in Step S4. However, the aforementioned production method is preferred from the viewpoint of easiness of the filling.

Here, the second porous layer 23 is preferably provided so that it adheres to the first porous layer 22. Because, a poor adhesiveness at the interface of the first porous layer 22 and the second porous layer 23 lowers the proton (H⁺) conductivity to result in the lowering of the generating efficiency. Therefore, the electrolyte layer 7 may be formed between the first porous layer 22 and the second porous layer 23 as described above. For the electrolyte layer 7, Nafion (registered trade mark, by DuPont) can be exemplified.

For the formation method thereof, the electrolyte layer 7 can be formed on the principal surface of the first porous layer 22, for example, by dipping the first porous layer 22 into a Nafion (registered trade mark, by DuPont) solution, and then pulling up and drying it to remove the solvent. After that, as described above, the second porous layer 23 is put on the principal surface of the first porous layer 22, which is filled with the electrolyte 9 (in this example, Nafion (registered trade mark, by DuPont)), and then dried.

By providing such electrolyte layer 7, the adhesiveness between the first porous layer 22 and the second porous layer 23 can be improved. As the result, since the proton (H⁺) conductivity can be enhanced, the generating efficiency can be improved.

Even in case where the electrolyte layer 7 is not provided, surface modification treatment of the first porous layer 22 is preferably carried out for the purpose of improving the adhesiveness between the first porous layer 22 and the second porous layer 23. For example, in case where the first porous layer 22 is composed of an organic material and such oxide as silicon dioxide (SiO₂) is selected as the second porous layer 23, it is preferred to treat the surface of the first porous layer 22 so as to become hydrophilic. For the modification treatment method in this case, such a surface modification method as irradiation of ultraviolet light from an excimer lamp etc. can be exemplified. In particular, vacuum ultraviolet light having a wavelength of 172 nm that is emitted from an excimer lamp has a strong photon energy and can irradiate a large area, and thus can enhance the efficiency of the modification treatment. The surface modification treatment is preferably carried out also in case where the aforementioned electrolyte layer 7 is to be provided.

By carrying out such surface modification treatment, the adhesiveness between the first porous layer 22 and the second porous layer 23 can be improved. As the result, since the proton (H⁺) conductivity can be enhanced, the generating efficiency can be improved.

Next, a sixth Example of the present embodiment is described.

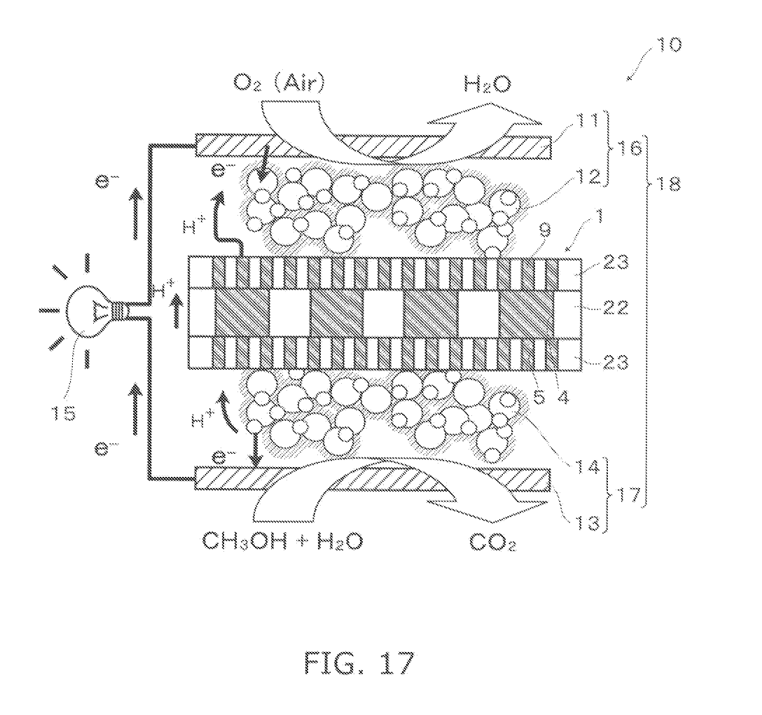

FIG. 17 is a schematic view for illustrating the fuel cell according to the sixth Example of the present embodiment. For the sake of simplicity, the description will be given on the basis of a direct methanol fuel cell (DMFC) that uses methanol as the fuel.

As shown in FIG. 17, a fuel cell 10 is provided with a membrane electrode assembly (MEA) 18 that is disposed with the solid electrolyte membrane 1 as described in FIG. 1, a cathode electrode 16 and an anode electrode 17. The membrane electrode assembly 18 is housed in a case (not shown). For the solid electrolyte membrane, one described in FIG. 13, FIG. 14 or FIG. 15 may be employed.

The solid electrolyte membrane 1 is provided with the first porous layer 22, and the second porous layers 23 that are formed on the principal surface thereof, as described above. And there is provided the through-holes 4 in a labyrinth figure to the first porous layer 22, and the openings 5 to the second porous layer 23. The through-holes 4 and the openings 5 are filled with the electrolyte 9.

As a specific example, the first porous layer 22 may be constituted of a polysilazane oxide porous membrane having a thickness of 25 μm and an opening ratio of 45%, and the second porous layer 23 may be constituted of polyimide porous membrane having a thickness of around 0.5 μm. The material of the electrolyte 9 may be Nafion (registered trade mark, by DuPont).

For a current collector 11 of the cathode electrode 16, a porous carbon woven fabric or carbon paper (content of PTFE (Polytetrafluoroethylene) is around 5% by weight) having been subjected to a water-repellent treatment of impregnating a PTFE solution can be employed. For the catalyst 12 of the cathode electrode 16, one having fine particles of platinum (Pt) that are supported on a granular or fibrous carbon such as activated carbon or graphite can be employed. In this case, the content of platinum (Pt) in the catalyst is preferably around from 10% by weight to 70% by weight.

For the current collector 13 of the anode electrode 17, a porous carbon woven fabric or carbon paper (content of PTFE is around 5% by weight) having been subjected to a water-repellent treatment of impregnating a PTFE (Polytetrafluoroethylene) solution can be employed. For the catalyst 14 of the anode electrode, one having fine particles of platinum (Pt)-ruthenium (Ru) that are supported on a granular or fibrous carbon such as activated carbon or graphite can be employed. In this case, the total content of platinum (Pt) and ruthenium (Ru) in the catalyst is preferably around from 10% by weight to 70% by weight. For the weight ratio of platinum (Pt) to ruthenium (Ru), platinum (Pt):ruthenium (Ru) is preferably around from 5:1 to 1:2. The current collector 11 and the current collector 13 are connected electrically with a load 15.

In addition, on the cathode electrode 16 side, a plurality of air vents are provided for supplying air (oxygen: O₂) or discharging generated water as water vapor, although the drawing thereof is omitted. On the anode electrode 17 side, provided are a fuel-supplying port for supplying fuel (methanol aqueous solution) and a fuel vent for discharging residual fuel (methanol aqueous solution) or carbon dioxide (CO₂) that has been generated through the reaction.

The material, size, cross-sectional figure, aperture figure, arrangement, component ratio and the like that are shown as specific examples are not limited to these, but they can be changed arbitrarily.

Next, the action of a fuel cell 10 is described.

When a methanol aqueous solution being fuel is supplied from a fuel-supplying port to the anode electrode 17 side, there occurs an oxidation reaction of the methanol aqueous solution that is represented by the following formula (1) in the presence of the catalyst 14 of the anode electrode 17. As the result of this reaction, carbon dioxide CO₂, proton (H⁺) and electron (e⁻) are generated. The proton (H⁺) permeates through the solid electrolyte membrane 1 and moves to the cathode electrode 16 side. The electron (e⁻) performs work while passing through the load 15 and then moves to the cathode electrode 16 side.

CH₃OH+H₂O→CO₂+6H⁺+6e⁻ (1)

The proton (H⁺) that has reached the cathode electrode 16 side, the electron (e⁻) that has reached the cathode electrode 16 side after performing work while passing through the load 15, and oxygen O₂ in air produce the reduction reaction that is represented by the formula (2) in the presence of the catalyst 12 of the cathode electrode 16.

6H⁺+6e⁻+3/2O₂→3H₂O (2)

The carbon dioxide (CO₂) that is produced on the anode electrode 17 side is discharged from the fuel vent to the outside with a residual methanol aqueous solution. The water that is produced on the cathode electrode 16 side is discharged from the air vent as vapor.

The fuel cell according to the present Example is provided with the aforementioned solid electrolyte membrane. Consequently, according to the present Example, a fuel cell that has a high membrane strength and a high generating efficiency by inhibiting the permeation of organic fuel (e.g., methanol crossover) can be obtained. In particular, a fuel cell having a high reliability and high efficiency can be realized as the desorption of the electrolyte can be prevented

Next, the method of manufacturing a fuel cell according to a seventh Example of the present embodiment is described.

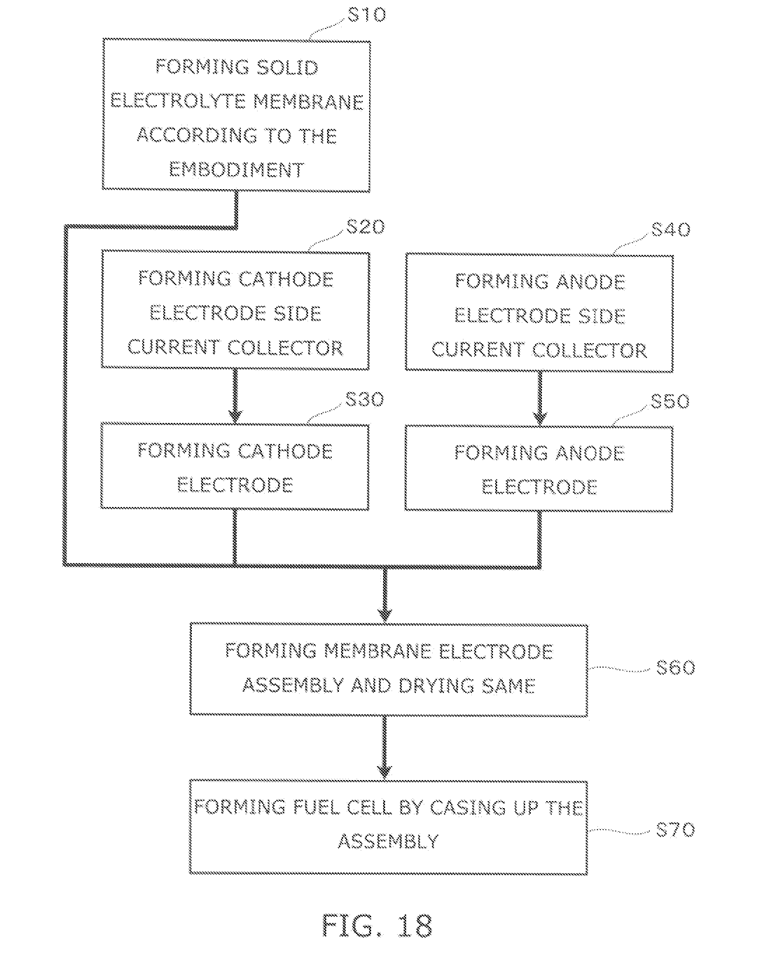

FIG. 18 is a flowchart for illustrating the method of manufacturing a fuel cell according to the seventh Example of the present embodiment.

The solid electrolyte membrane 1 according to the embodiment is formed by the aforementioned method (Step S10). The solid electrolyte membrane may be one that is described for FIG. 13, FIG. 14 or FIG. 15.

A porous carbon woven fabric or carbon paper is impregnated with a PTFE (Polytetrafluoroethylene) solution to form the current collector 11 on the cathode electrode 16 side (Step S20). In this occasion, the PTFE content is determined to around 5% by weight.

Next, fine particles of platinum (Pt), granular or fibrous carbon of activated carbon or graphite, and a solvent are mixed to be pasty, which is coated on the current collector 11 to be used as the catalyst 12, thereby forming the cathode electrode 16 (Step S30). In this occasion, the platinum (Pt) content in the catalyst 12 is preferably around from 10% by weight to 70% by weight.

On the other hand, a porous carbon woven fabric or carbon paper is impregnated with a PTFE (Polytetrafluoroethylene) solution to form the current collector 13 on the anode electrode 17 side (Step S40). In this occasion, the PTFE content is determined to around 5% by weight.

Next, fine particles of platinum (Pt)-ruthenium (Ru), granular or fibrous carbon of activated carbon or graphite, and a solvent are mixed to be pasty, which is coated on the current collector 13 to be used as the catalyst 14, thereby forming the cathode electrode 17 (Step S50). In this occasion, the total content of the platinum (Pt) and the ruthenium (Ru) in the catalyst 14 is preferably around from 10% by weight to 70% by weight. For the weight ratio of the platinum (Pt) to the ruthenium (Ru), preferably platinum (Pt):ruthenium (Ru) is around from 5:1 to 1:2.

Next, the solid electrolyte membrane 1, the cathode electrode 16 and the anode electrode 17 thus formed are used for forming the membrane electrode assembly 18, which is dried (Step S60). In this occasion, the drying is preferably carried out in such an inert gas as nitrogen or argon (Ar), or in vacuum.

Finally, it is housed in a case arbitrarily to form the fuel cell 10 (Step S70).

Up to now, embodiments of the present invention have been described with reference to specific examples. But the present invention is not limited to these specific examples.

Such products or methods that are induced from the above-described specific examples based on arbitrary design changes by a person skilled in the art are included also within the scope of the present invention, as long as they are provided with the characteristics of the present invention.

For example, for a catalyst 14 on the anode electrode 17 side, any one may be acceptable, provided that it can oxidize the organic fuel. It may be, for example, fine particles of alloy that is composed of platinum and at least one metal selected from the group consisting of iron, nickel, cobalt, tin, ruthenium and gold.

For a fuel cell, one that is constituted of a single membrane electrode assembly is shown, but it may be one that has a stuck structure that is formed by laminating a plurality of membrane electrode assemblies.

Further, for fuel, a methanol aqueous solution is exemplified and the permeation thereof through the solid electrolyte membrane is described as “methanol crossover,” but fuel is not limited to this, and the same effect can be expected for other organic fuel. For other organic fuel, in addition to methanol, alcohols such as ethanol and propanol, ethers such as dimethyl ether, cycloparaffins such as cyclohexane, and cycloparaffins having a hydrophilic group such as a hydroxyl group, carboxyl group, amino group or amide group can be exemplified. Such organic fuel is used usually as an aqueous solution of around 5-90% by weight.

1. A solid electrolyte membrane comprising:
a porous material layer having a through-hole that is filled with an electrolyte, and
an inorganic material layer that is provided so as to face to at least either side of a principal surface of the porous material layer and has an opening that is filled with an electrolyte.

2. The solid electrolyte membrane according to claim 1, further comprising an electrolyte layer that is provided between the porous material layer and the inorganic material layer.

3. The solid electrolyte membrane according to claim 2, wherein the thickness of the electrolyte layer is 10 μm or less.

4. The solid electrolyte membrane according to claim 1, wherein the porous material layer is composed of an organic material.

5. The solid electrolyte membrane according to claim 1, wherein the thickness of the porous material layer is 0.01 μm or more and 100 μm or less.

6. The solid electrolyte membrane according to claim 1, wherein the thickness of the inorganic material layer is 0.01 μm or more and 100 μm or less.

7. A solid electrolyte membrane comprising:
a first porous layer having a through-hole that is filled with an electrolyte, and
a second porous layer that is provided so as to face to at least either side of a principal surface of the first porous layer and has an opening that is filled with an electrolyte,
the average diameter of the opening being smaller than the average diameter of the through-hole.

8. The solid electrolyte membrane according to claim 7 wherein the average diameter d1 of the through-hole and the average diameter d2 of the opening satisfy the following formula:
d1/(1+α)>d2
wherein α is the swelling percentage of the electrolyte, d1 is the average diameter of the through-hole, and d2 is the average diameter of the opening.

9. The solid electrolyte membrane according to claim 7, further comprising an electrolyte layer that is provided between the first porous layer and the second porous layer.

10. The solid electrolyte membrane according to claim 9, wherein the thickness of the electrolyte layer is 10 μm or less.

11. The solid electrolyte membrane according to claim 7, wherein the second porous layer is provided with a labyrinth-like opening.

12. A method of manufacturing a solid electrolyte membrane comprising:
forming an inorganic material layer so as to face to a principal surface of a porous material layer having a through-hole;
forming an opening for the inorganic material layer; and
filling the through-hole and the opening with an electrolyte.

13. The method of manufacturing a solid electrolyte membrane according to claim 12, further comprising forming an electrolyte layer so as to face to the principal surface of the porous material layer, prior to forming the inorganic material layer.

14. A method of manufacturing a solid electrolyte membrane comprising:
forming a first porous layer having a through-hole;
forming a second porous layer having an opening;
putting the second porous layer on a principal surface of the first porous layer; and
filling the through-hole and the opening with an electrolyte.

15. The method of manufacturing a solid electrolyte membrane according to claim 14, further comprising forming an electrolyte layer on the principal surface of the first porous layer before putting the second porous layer on a principal surface of the first porous layer.

16. A fuel cell comprising:
the solid electrolyte membrane including:
a porous material layer having a through-hole that is filled with an electrolyte, and
an inorganic material layer that is provided so as to face to at least either side of a principal surface of the porous material layer and has an opening that is filled with an electrolyte;
a cathode electrode; and
an anode electrode.

17. The fuel cell according to claim 16, wherein the inorganic material layer is provided on a side having a catalyst with a higher catalyst efficiency between the cathode electrode and the anode electrode.

18. A fuel cell comprising:
a first porous layer having a through-hole that is filled with an electrolyte, and
a second porous layer that is provided so as to face to at least either side of a principal surface of the first porous layer and has an opening that is filled with an electrolyte,
the average diameter of the opening being smaller than the average diameter of the through-hole;
a cathode electrode; and
an anode electrode.

19. A method of manufacturing a fuel cell comprising:
producing a solid electrolyte membrane including:
forming an inorganic material layer so as to face to a principal surface of a porous material layer having a through-hole;
forming an opening for the inorganic material layer; and
filling the through-hole and the opening with an electrolyte;
forming a current collector on a cathode electrode side and forming a catalyst thereon to form a cathode electrode;
forming a current collector on an anode electrode side and forming a catalyst thereon to form an anode electrode; and
joining the cathode electrode and the anode electrode on both sides of the solid electrolyte membrane.

20. A method of manufacturing a fuel cell comprising:
producing a solid electrolyte membrane including:
forming a first porous layer having a through-hole;
forming a second porous layer having an opening;
putting the second porous layer on a principal surface of the first porous layer; and
filling the through-hole and the opening with an electrolyte;
forming a current collector on a cathode electrode side and forming a catalyst thereon to form a cathode electrode;
forming a current collector on an anode electrode side and forming a catalyst thereon to form an anode electrode; and
joining the cathode electrode and the anode electrode on both sides of the solid electrolyte membrane.
